(19) United States
(12) Patent Application Publication
(10) Pub. No.: US 2022/0383109 A1
(43) Pub. Date: Dec. 1, 2022

(54) SYSTEM AND METHOD FOR CONTINUOUS DYNAMICS MODEL FROM IRREGULAR TIME-SERIES DATA

(71) Applicant: ROYAL BANK OF CANADA, Toronto (CA)

(72) Inventors: Ruizhi DENG, Coquitlam (CA); Marcus Anthony BRUBAKER, Toronto (CA); Gregory Peter MORI, Burnaby (CA); Andreas Steffen Michael LEHRMANN, Vancouver (CA)

(21) Appl. No.: 17/749,678

(22) Filed: May 20, 2022

Related U.S. Application Data
(60) Provisional application No. 63/191,641, filed on May 21, 2021.

(51) Int. Cl. G06N 3/08; G06F 17/13

(52) U.S. Cl. CPC G06N 3/08; G06F 17/13

(57) ABSTRACT

A system for machine learning architecture for time series data prediction. The system may be configured to: maintain a data set representing a neural network having a plurality of weights; obtain time series data associated with a data query; generate, using the neural network and based on the time series data, a predicted value based on a sampled realization of the time series data and a normalizing flow model, the normalizing flow model based on a latent continuous-time stochastic process having a stationary marginal distribution and bounded variance; and generate a signal providing an indication of the predicted value associated with the data query.

### CROSS-REFERENCE TO RELATED APPLICATION

This application claims the benefit of and priority to U.S. provisional patent application No. 63/191,641, filed on May 21, 2021, the entire content of which is herein incorporated by reference.

### FIELD

Embodiments of the present disclosure relate to the field of machine learning, and in particular to machine learning architecture for time series data prediction.

### BACKGROUND

Stochastic processes may include a collection of random variables that may be indexed by time. Normalizing flows may include operations for transforming a base distribution into a complex target distribution, thereby providing models for data generation or probability density estimation. Expressive models for sequential data can contribute to a statistical basis for data prediction or generation tasks in a wide range of applications, including computer vision, robotics, financial technology, among other examples.

### SUMMARY

Embodiments of the present disclosure may be may be applicable to natural processes such as environmental conditions (e.g., temperature of a room throughout a day, wind speed over a period of time), speed of a travelling vehicle over time, electricity consumption over a period of time, valuation of assets in the capital markets, among other examples.

In practice, such example natural processes may be continuous processes having data sets generated based on discrete data sampling, which may occur at arbitrary points in time (e.g., arbitrarily obtained timestamped data). Modelling such natural processes may include inherent properties based on previous points in time, which may result in a potentially unmanageable matrix of variable or data dependencies. In some scenarios, such natural processes may be modeled with simple stochastic process such as the Weiner process, which may have the Markov property (e.g., memoryless property of the stochastic process). It may be beneficial to provide generative models that may be more expressive.

Accordingly, systems and methods of defining and sampling from a flexible variational posterior process unconstrained by a Markov process based on a piece-wise evaluation of stochastic differential equations may be provided in the present disclosure. Embodiments of the present disclosure may include models for fitting observations on irregular time grids, generalizing to observations on more dense time grids, or generating trajectories continuous in time.

Systems disclosed herein may include machine learning architecture having flow-based decoding of a generic stochastic differential equation as a principled framework for continuous dynamics modeling from irregular time-series data. The variational approximation of the observational likelihood may be improved by a non-Markovian posterior-process based on a piece-wise evaluation of the underlying stochastic differential equation.

In one aspect, the present disclosure may provide a system for machine learning architecture for time series data prediction comprising: a processor; and a memory coupled to the processor. The memory may store processor-executable instructions that, when executed, configure the processor to: obtain time series data associated with a data query; generate a predicted value based on a sampled realization of the time series data and a latent normalizing flow model, the latent normalizing flow model based on a stochastic process having a stationary marginal distribution and bounded variance; and generate a signal providing an indication of the predicted value associated with the data query.

In some embodiments, the time series data may be asynchronous data or irregularly spaced time data.

In another aspect, the present disclosure may provide a method for machine learning architecture for time series data prediction comprising: obtaining time series data associated with a data query; generating a predicted value based on a sampled realization of the time series data and a latent normalizing flow model, the latent normalizing flow model based on a stochastic process having a stationary marginal distribution and bounded variance; and generating a signal providing an indication of the predicted value associated with the data query.

In some embodiments, the time series data may be asynchronous data or irregularly spaced time data.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

In accordance with one aspect, there is provided a system for machine learning architecture for time series data prediction, the system may include: a processor; and a memory coupled to the processor and storing processor-executable instructions that, when executed, configure the processor to: maintain a data set representing a neural network having a plurality of weights; obtain time series data associated with a data query; generate, using the neural network and based on the time series data, a predicted value based on a sampled realization of the time series data and a normalizing flow model, the normalizing flow model based on a latent continuous-time stochastic process having a stationary marginal distribution and bounded variance; and generate a signal providing an indication of the predicted value associated with the data query.

In some embodiments, the memory includes processor-executable instructions that, when executed, configure the processor to determine a log likelihood of observations with a variational lower bound.

In some embodiments, the variational lower bound is based on a piece-wise construction of a posterior distribution of a latent continuous-time stochastic process.

In some embodiments, the normalizing flow model (F_{θ}) is configured to decode a continuous time sample path of a latent state into a complex distribution of continuous trajectories.

In some embodiments, F_{θ} is a continuous mapping and one or more sampled trajectories of the latent continuous-time stochastic process are continuous with respect to time.

In some embodiments, the latent state has m+1 dimensions, and wherein m is derived from the latent continuous-time stochastic process.

In some embodiments, a variational posterior of the latent state is based on piece-wise solutions of latent differential equations.

In some embodiments, the latent continuous-time stochastic process comprises an Ornstein-Uhlenbeck (OU) process having the stationary marginal distribution and bounded variance.

In some embodiments, the latent continuous-time stochastic process is configured such that transition density between two arbitrary time points is determined in closed form.

In some embodiments, the time series data comprises sensor data obtained from one or more physical sensor devices.

In some embodiments, the time series data comprises irregularly spaced temporal data.

In some embodiments, the predicted value comprises an interpolation between two data points from the time series data.

In accordance with another aspect, there is a computer-implemented method for machine learning architecture for time series data prediction comprising: maintaining a data set representing a neural network having a plurality of weights; obtaining time series data associated with a data query; generating, using the neural network and based on the time series data, a predicted value based on a sampled realization of the time series data and a normalizing flow model, the normalizing flow model based on a latent continuous-time stochastic process having a stationary marginal distribution and bounded variance; and generating a signal providing an indication of the predicted value associated with the data query.

In some embodiments, the method may include determining a log likelihood of observations with a variational lower bound.

In some embodiments, the variational lower bound is based on a piece-wise construction of a posterior distribution of a latent continuous-time stochastic process.

In some embodiments, the normalizing flow model (F₉) is configured to decode a continuous time sample path of a latent state into a complex distribution of continuous trajectories.

In some embodiments, F_{θ} is a continuous mapping and one or more sampled trajectories of the latent continuous-time stochastic process are continuous with respect to time.

In some embodiments, the latent state has m+1 dimensions, and wherein m is derived from the latent continuous-time stochastic process.

In some embodiments, a variational posterior of the latent state is based on piece-wise solutions of latent differential equations.

In some embodiments, the latent continuous-time stochastic process comprises an Ornstein-Uhlenbeck (OU) process having the stationary marginal distribution and bounded variance.

In some embodiments, the latent continuous-time stochastic process is configured such that transition density between two arbitrary time points is determined in closed form.

In some embodiments, the time series data comprises sensor data obtained from one or more physical sensor devices.

In some embodiments, the time series data comprises irregularly spaced temporal data.

In some embodiments, the predicted value comprises an interpolation between two data points from the time series data.

In accordance with yet another aspect, there is provided a non-transitory computer-readable medium having stored thereon machine interpretable instructions which, when executed by a processor, cause the processor to perform a computer-implemented method for machine learning architecture for time series data prediction, the method comprising: maintaining a data set representing a neural network having a plurality of weights; obtaining time series data associated with a data query; generating, using the neural network and based on the time series data, a predicted value based on a sampled realization of the time series data and a normalizing flow model, the normalizing flow model based on a latent continuous-time stochastic process having a stationary marginal distribution and bounded variance; and generating a signal providing an indication of the predicted value associated with the data query.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1A is a schematic diagram of a computer-implemented system for training a neural network for data prediction based on a time series data, in accordance with an embodiment;

FIG. 1B illustrates a system for machine learning architecture, in accordance with an embodiment of the present disclosure;

FIG. 2 is a schematic diagram of an machine learning application of the system of FIG. 1B, in accordance with an embodiment;

FIG. 3 is a schematic diagram of an example neural network, in accordance with an embodiment;

FIG. 4 illustrates a table representing quantitative evaluation of models, in accordance with embodiments of the present disclosure; and

FIG. 5 illustrates a flowchart of a method for machine learning architecture for time series data prediction, in accordance with embodiments of the present disclosure.

### DETAILED DESCRIPTION

Fields of science, including finance [27, 10], healthcare [11], and physics [24], may include sparse or irregular observations of continuous dynamics. Time-series models driven by stochastic differential equations (SDEs) may provide a framework for sparse or irregularly timed observations and may be applied with machine learning systems [7, 13, 19]. The SDEs may be implemented by neural networks with trainable parameters, and the latent process defined by SDEs may be decoded into an observable space with complex structure. As observations on irregular time grids may take place at arbitrary time stamps, models based on stochastic differential equations may be suitable for this type of data. Due to the lack of closed-form transition densities for most SDEs, dedicated numerical and Bayesian approximations may be used to maximize the observational log-likelihood of these models [1, 13, 19].

In some scenarios, stochastic differential equation based models may not be optimally applied to irregular time series data. In some scenarios, the model's representation power may not be optimal. A continuous-time flow process (CTFP; [7]) may utilize a series of invertible mappings continuously indexed by time to transform a Wiener process to a more complex stochastic process. Computing systems configured to conduct a latent process and invertible transformations may provide CTFP models for evaluating a likelihood of observations on any time grid more efficiently, but also limit the set of stochastic processes that CTFP may express to a specific form which may be obtained using Ito's Lemma. The above-described example may exclude a subset of stochastic processes.

In some scenarios, a limitation of representation power in practice may be the Lipschitz property of transformations in the models. The latent SDE model proposed by Hasan et al. [13] and CTFP may both transform a latent stochastic process with constant variance to an observable one using injective mappings. Due to the Lipschitz property existing in invertible neural network architectures, some processes that may be written as a non-Lipschitz transformation of a simple process, such as geometric Brownian motion, may not be expressed by these models unless specific choices of non-Lipschitz decoders are used.

Apart from the model's representation power, variational inference may be a limitation associated with training SDE-based models. The latent SDE model in the work of [19] uses a principled method of variational approximation based on the re-weighting of trajectories between a variational posterior and a prior process. The variational posterior process may be constructed using a single stochastic differential equation conditioned on the observations. As a result, it may be restricted to be a Markov process. The Markov property of the variational posterior process may limit its capability to approximate the true posterior well enough.

In some embodiments of the present disclosure, systems may be configured to provide a model governed by latent dynamics defined by an expressive generic stochastic differential equation. The dynamic normalizing flows [7] in the some embodiments decode each latent trajectory into a continuous observable process. Driven by different trajectories of the latent stochastic process continuously evolving with time, the dynamic normalizing flows may map a simple base process to a diverse class of observable processes. This decoding may be critical for the model to generate continuous trajectories and be trained to fit observations on irregular time grids using a variational approximation. Good variational approximation results may rely on a variational posterior distribution close to the true posterior conditioned on the observations.

In some embodiments of the present disclosure, systems may be configured to define and sample from a flexible variational posterior process that may not be constrained to be a Markov process based on piece-wise evaluation of stochastic differential equations. The system may be configured for fitting observations on irregular time grids, generalizing to observations on more dense time grids, and generating trajectories continuous in time.

Among the examples of time series methods with continuous dynamics, the latent SDE model [19] may be used. Although the latent SDE model may be based on an adjoint sensitivity method for training stochastic differential equations, the derivation of the variational lower bound of the proposed models disclosed in the present disclosure may be based on the same principle of trajectory re-weighting between two stochastic differential equations.

In some scenarios, the posterior process may be defined as a global stochastic differential equation. In contrast, some embodiments of the present disclosure may include systems configured to provide a model that may exploit the given observation time grid of each sequence to induce a piecewise posterior process with richer structure.

Hasan et al. [13] proposes a different formulation of learning stochastic differential equations as latent dynamics with variational approximation. Such a model may be configured to learn the latent dynamics from sequences of observations with fixed time intervals. Based on an Euler-Maruyam approximation of SDE solution, example systems may be configured to model the transition distribution between consecutive latent states as a Gaussian distribution. The latent state may then be mapped to a distribution in the higher-dimensional observation space. Due to this formulation, the model cannot be directly applied to our problem settings and compared with the proposed models. Kidger et al. [15] discloses systems configured to train neural SDEs as a generative adversarial network (GAN) with dense observations.

In some examples of continuous-time flow process [7] (CTFP) models, irregular time series data may be incomplete realization of continuous-time stochastic processes. Because CTFP may be a generative model that generates continuous trajectories, in some embodiments, the system may be configured to use it as the decoder of a latent process for better inductive bias in modeling continuous dynamics. The latent process may be a latent continuous-time stochastic process, for example.

In some embodiments, a latent ODE and ODE-RNN models can be implemented to propagate a latent state across time based on ordinary differential equations. As a result, the entire latent trajectory may be determined by its initial value. Even though latent ODE models may have continuous latent trajectories, the latent state may be decoded into observations at each time step independently. Neural controlled differential equations (CDEs) and rough differential equations (RDEs) may propagate a hidden state across time continuously using controlled differential equations driven by functions of time interpolated from observations on irregular time grids. While the above described example models can be applied to various inference tasks on irregular time series, these examples may not be a generative model of time series data.

Embodiments of the present disclosure describes systems for machine learning architecture for addressing one or more limitations of above-described example models. As will be described in the present disclosure, systems may be configured to provide a flow-based decoding of a generic stochastic differential equation as a principled framework for continuous dynamics modeling from irregular time-series data.

Some embodiments of the present disclosure may improve the variational approximation of the observational likelihood through a non-Markovian posterior process based on a piece-wise evaluation of the underlying stochastic differential equation. In some embodiments, systems may be configured based on a series of ablation studies and comparisons to state-of-the-art time-series models, both on synthetic and real-world datasets. Embodiments of the present disclosure may be based on prior systems configured based on stochastic differential equations and continuously indexed normalizing flows.

Stochastic differential equations may be a stochastic analogue of ordinary differential equations in the sense that

$$\frac{{dZ}_{t}}{dt} = μ ( {Z}_{t} , t ) + random noise \cdot σ ( {Z}_{t} , t ) .$$

Let Z be a variable which may continuously evolve with time. An m-dimensional stochastic differential equation describing the stochastic dynamics of Z may be provided as:

dZₜ=μ(Zₜ,t)dt+σ(Zₜ,t)dWₜ, (1)

where μ maps to an m-dimensional vector, a is an m×k matrix, and Wₜ is a k-dimensional Wiener process. The solution of a stochastic differential equation may be a continuous-time stochastic process Zₜ that satisfies the following integral equation with initial condition Z₀,

Zₜ=Z₀+∫₀^{t}μ(Zₛ,s)ds+∫₀^{t}σ(Zₛ,s)dWₛ, (2)

where the stochastic integral should be interpreted as a traditional Itô integral [21, Chapter˜3.1]. For each sample trajectory ω˜Wₜ, the stochastic process Zₜ maps ω to a different trajectory Zₜ (ω).

In some scenarios, stochastic differential equations may be used as models of latent dynamics in a variety of contexts [19, 13, 1]. As closed-form finite-dimensional solutions to SDEs may be relatively rare, numerical or variational approximations may be used in practice. Li et al. [19] describes a principled method of re-weighting the trajectories of latent SDEs for variational approximations using Girsanov's theorem [21, Chapter 8.6]. For example, consider a prior process and a variational posterior process in the interval [0, T] defined by two stochastic differential equations dZₜ=μ₁(Zₜ, t) dt+σ(Zₜ,t) dWₜ and d\hat{Z}ₜ=μ₂(\hat{Z}ₜ, t) dt+σ(\hat{Z}ₜ,t) dWₜ, respectively. Furthermore, let p(x|Zₜ) denote the probability of observing x conditioned on the trajectory of the latent process Zₜ in the interval [0, T]. If there exists a mapping u: [symbol] ^{m}×[0, T]→ [symbol] ^{k} such that

σ(z,t)u(z,t)=μ₂(z,t)−μ₁(z,t) (3)

and u satisfies Novikov's condition [21, Chapter 8.6], we may obtain the variational lower bound

log p(x)=log [symbol] [p(x|Zₜ)]=log [symbol] [p(x|\hat{Z}ₜ)M_{T}]≥ [symbol] [log p(x|\hat{Z}ₜ)+log M_{T}], (4)

where

$${M}_{T} = exp ( - {\int }_{0}^{T} \frac{1}{2} {\vert u ( {\hat{Z}}_{t} , t ) \vert}^{2} dt - {\int }_{0}^{T} {u ( {\hat{Z}}_{t} , t )}^{T} {dW}_{t} ) .$$

See [19] for a formal proof.

Normalizing flows [25, 8, 17, 9, 23, 16, 2, 4, 18, 22] may employ a bijective mapping f: [symbol] ^{d}→ [symbol] ^{d} to transform a random variable Y with a simple base distribution p_{Y} to a random variable X with a complex target distribution p_{X}. In some scenarios, methods may include sampling from a normalizing flow by first sampling y˜p_{y} and then transforming it to x=f(y). As a result of invertibility, normalizing flows can also be used for density estimation. Using the change-of-variables formula, the following may be provided:

$$log {p}_{X} ( x ) = log {p}_{Y} ( g ( x ) ) + log \vert det ( \frac{\partial g}{\partial x} ) \vert , \qquad ( 5 )$$

where g is the inverse of f.

In some scenarios, normalizing flows may be augmented with a continuous index [3, 7, 6]. For instance, the continuous-time flow process (CTFP; [7]) models irregular observations of a continuous-time stochastic process. Specifically, CTFP transforms a simple d-dimensional Wiener process Wₜ to another continuous stochastic process Xₜ using the transformation

Xₜ=f(Wₜ,t), (6)

where f(w,t) is an invertible mapping for each t. Despite its benefits of exact log-likelihood computation of arbitrary finite-dimensional distributions, the expressive power of CTFP to model stochastic processes may be limited in at least two aspects: (1) An application of Itô's lemma [21, Chapter 4.2] shows that CTFP can only represent stochastic process of the form

$$df ( {W}_{t} , t ) = \{ \frac{df}{dt} ( {W}_{t} , t ) + \frac{1}{2} Tr ( {H}_{W} f ( {W}_{t} , t ) ) \} dt + {( {▽}_{W} {f}^{T} ( {W}_{t} , t ) )}^{T} {dW}_{t} , \qquad ( 7 )$$

where H_{w}f is the Hessian matrix of f with respect to w and ∇_{w}f is the derivative. A variety of stochastic processes, from simple processes like the commonly used Ornstein-Uhlenbeck (OU) process to more complex non-Markov processes, may fall outside of this limited class and cannot be learned using CTFP; or (2) Many normalizing flow architectures may be compositions of Lipschitz-continuous transformations [4, 5, 12]. Certain stochastic processes that are non-Lipschitz transformations of simple processes cannot be modeled by CTFP without prior knowledge about the functional form of the observable processes and custom-tailored normalizing flows with non-Lipschitz transformations [14]. For example, geometric Brownian motion (GBM) may be written as an exponential transformation of Brownian motion, but it may not be possible for CTFP models to represent geometric Brownian motion unless an exponential activation function is added to the output.

A latent variant of CTFP may be further augmented with a static latent variable to introduce non-markov property into the model. It models continuous stochastic processes as Xₜ=f(Wₜ, t; Z) where Z is a latent variable with standard Gaussian distribution and f(·,·; z) is a CTFP model that decode each sample z of Z into a stochastic processes with continuous trajectories. Latent CTFP model may be used to estimate finite dimensional distributions with variational approximation. However, in some scenarios, it may not be clear how the static latent variable with finite dimensions can improve the representation power of modeling continuous stochastic processes.

Modern time series data may pose challenges for the existing machine learning techniques both in terms of their structure (e.g., irregular sampling in hospital records and spatiotemporal structure in climate data) and size. Embodiments disclosed herein are adapted to train a machine learning model having a neural network to make data prediction based on irregular time series data.

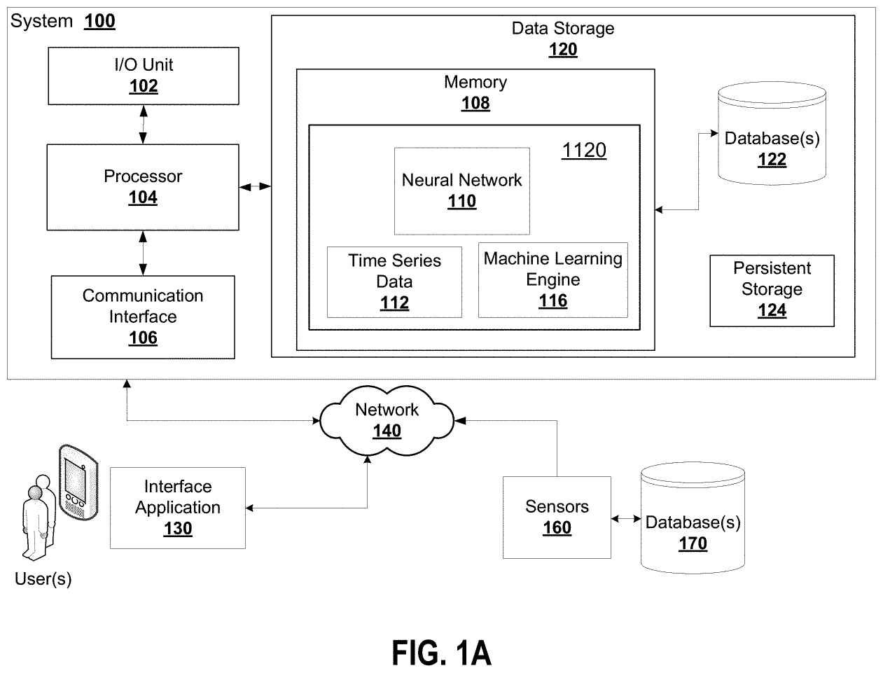

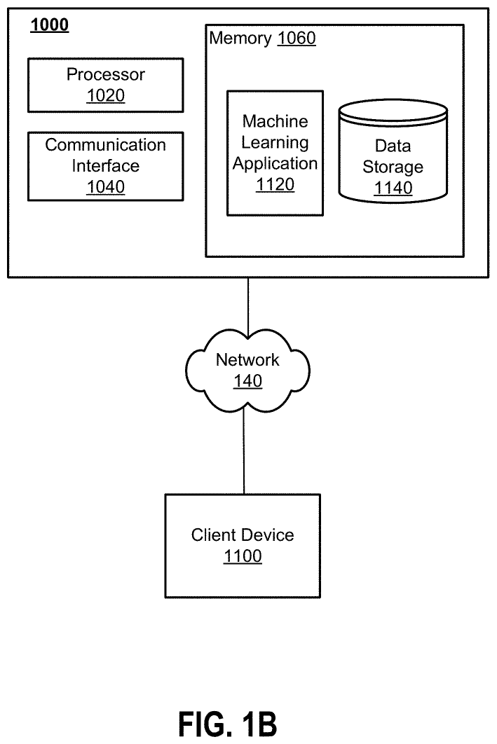

FIG. 1A is a schematic diagram of a computer-implemented system 100 for training a neural network 110 for data prediction based on a time series data 112, in accordance with an embodiment.

A machine learning application 1120 can maintain a neural network 110 to perform actions based on input data 112. The machine learning application 1120 may include a machine learning engine 116 that is implemented to use a generative model for continuous stochastic process to train the neural network 110. For example, the machine learning application 1120 may use a continuous-time flow process (CTFP) or a latent CTFP model to train the neural network 110.

In various embodiments, system 100 is adapted to perform certain specialized purposes. In some embodiments, system 100 is adapted to train neural network 110 for predicting one or more future values based on a time series data 112, which may be irregular time series data 112.

In some embodiments, the time series data that are used as a basis for prediction may include irregularly spaced temporal data. Irregularly spaced temporal data may be asynchronous data. Asynchronous data may include data points or measurements that do not need to follow a regular pattern (e.g., once per hour); instead, the data points can be arbitrarily spaced.

For instance, the time series data 112 may include an unevenly (or irregularly) spaced data values or data points that form a sequence of timestamp and value pairs (tₙ, Xₙ) in which the spacing of timestamps is not constant. Such unevenly (or irregularly) spaced time series data occurs naturally in many aspects, such as physical world (e.g., floods, volcanic eruptions, astronomy), clinical trials, climatology, and signal processing.

The system 100 may use trained neural network 110 to make data extrapolation or interpolation based on the irregularly spaced time series data 112. As further described below, data extrapolation may mean that making a value prediction at a future timestamp: taking data values at points x₁, . . . , xₙ within the time series data 112, and approximating a value outside the range of the given points. Data interpolation, on the other hand, may mean a process of using known data values in the time series data 112 to estimate unknown data values between two arbitrary data points within the time series data 112.

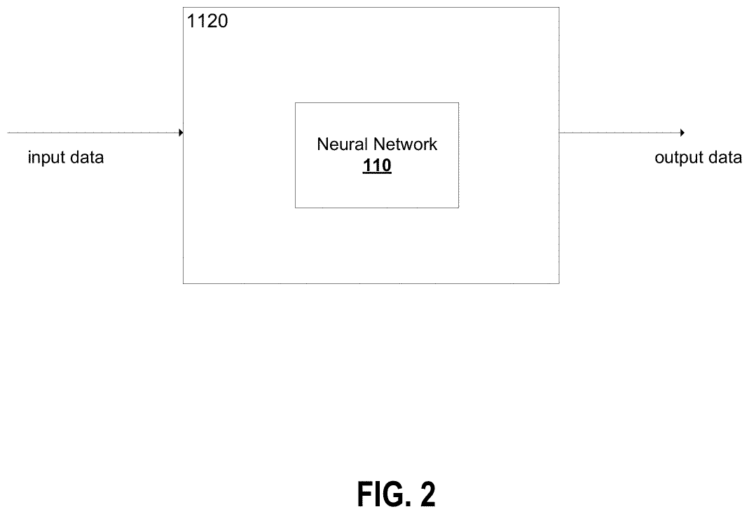

FIG. 2 is a schematic diagram of an machine learning application 1120 of the system 100 of FIG. 1A, in accordance with an embodiment. As depicted in FIG. 2, machine learning application 1120 receives input data and generates output data according to its machine learning network 110. Machine learning application 1120 may interact with one or more sensors 160 to receive input data or to provide output data.

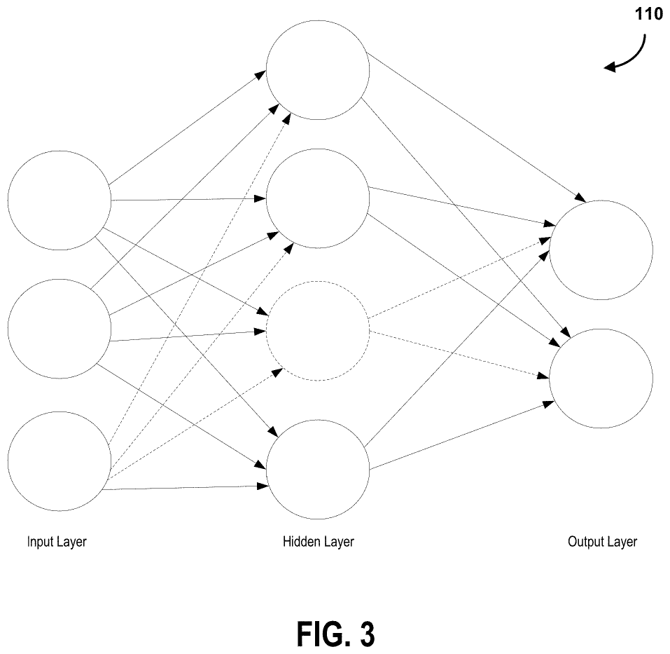

FIG. 3 is a schematic diagram of an example neural network 110, in accordance with an embodiment. The example neural network 110 can include an input layer, a hidden layer, and an output layer. The neural network 110 processes input data using its layers based on machine learning, for example.

Once the machine learning application 1120 has been trained, it generates output data reflective of its decisions to take particular actions in response to particular input data. Input data include, for example, a set of a time series data 112 obtained from one or more sensors 160, which may be stored in databases 170 in real time or near real time.

As a practical example, a HVAC control system which may be configured to set and control heating, ventilation, and air conditioning units (HVAC) for a building, in order to efficiently manage the power consumption of HVAC units, the control system may receive sensor data representative of temperature data in a historical period. The control system may use a trained machine learning application 1120 to make a data prediction regarding a potential future value representing the predicted room temperature based on the sensor data representative of the temperature data in the historical period (e.g., the past 72 hours or the past week).

The sensor data may be a time series data 112 that is gathered from sensors 160 placed at various points of the building. The measurements from the sensors 1160, which form the time series data 112, may be discrete in nature. For example, the time series data 112 may include a first data value 21.5 degrees representing the detected room temperature in Celsius at time t₁, a second data value 23.3 degrees representing the detected room temperature in Celsius at time t₂, a third data value 23.6 degrees representing the detected room temperature in Celsius at time t₃, and so on.

Even though temperature in general is continuous in nature, the measurements through sensors 160 are discrete. The machine learning application 1120 can infer, through the trained neural network 110, the underlying dynamic nature of the time series data 112 representing the historical room temperature values, and thereby make a prediction of a future room temperature value at t=tₙ, based on the time series data 112. Based on the predicted future room temperature value at tₙ, the control system may then decide whether and when the heating or AC unit needs to be turned on or off in order to reach or maintain an ideal room temperature.

In some embodiments, the prediction output from the machine learning application 1120 based on the time series data 112 is a probability value or a set of probability values. The final output of the machine learning application 1120 is the predicted data value associated with the highest probability.

As another example, in some embodiments, a traffic control system which may be configured to set and control traffic flow at an intersection. The traffic control system may receive sensor data representative of detected traffic flows at various points of time in a historical period. The traffic control system may use a trained machine learning application 1120 to generate a data prediction regarding a potential future value representing the predicted traffic flow based on the sensor data representative of the traffic flow data in the historical period (e.g., the past 4 or 24 hours).

The sensor data may be a time series data 112 that is gathered from sensors 160 placed at one or more points close to the traffic intersection. The measurements from the sensors 1160, which form the time series data 112, may be discrete in nature. For example, the time series data 112 may include a first data value 3 vehicles representing the detected number of cars at time a second data value 1 vehicles representing the detected number of cars at time t₂, a third data value 5 vehicles representing the detected number of cars at time t₃, and so on.

Traffic flow in general is continuous in nature, the measurements through sensors 160 are discrete, and the machine learning application 1120 can infer the underlying dynamic nature of the time series data 112 representing the historical traffic flow (number of vehicles detected at a particular location during a time period), and make a prediction of a future traffic flow at t=tₙ, based on the time series data 112. Based on the predicted traffic flow value at tₙ, the traffic control system may then decide to shorten or lengthen a red or green light signal at the intersection, in order to ensure the intersection is least likely to be congested during one or more points in time.

As yet another example, the time series data 112 may represent a set of measured blood pressure values or blood sugar levels in a time period measured by one or more medical devices having sensors 160. The trained machine learning application 1120 may receive the time series data 112 from the sensors 160 or a database 170, and generate an output representing a predicted data value representing a future blood pressure value or a future blood sugar level. The predicted data value may be transmitted to a health care professional for monitoring or medical purposes.

The blood pressure values or blood sugar levels are continuous in nature. The measurements through sensors 160 are discrete, and the machine learning application 1120 can infer the underlying dynamic nature of the time series data 112 representing the blood pressure values or blood sugar levels, and make a prediction of a future blood pressure value or a future blood sugar level at t=tₙ, based on the time series data 112.

In some embodiments, the system 100 may include machine learning architecture such as machine learning application 1120 to configure a processor to conduct flow-based decoding of a generic stochastic differential equation as a principled framework for continuous dynamics modeling from irregular time-series data.

In some embodiments, the machine learning application 1120 may be configured to conduct variational approximation of observational likelihood associated with a non-Markovian posterior-process based on a piece-wise evaluation of the underlying stochastic differential equation.

In some embodiments, the machine learning application 1120 may be configured to provide a Latent SDE Flow Process described herein. Let {(xₜ_{ᵢ}, tᵢ)}ᵢ₌₁ⁿ, denote a sequence of d-dimensional observations sampled on a given time grid where tᵢ denotes the time stamp of the observation and xₜ_{ᵢ} is the observation's value. The observations may be partial realizations of a continuous-time stochastic processes Xₜ. Systems may be configured to maximize the log likelihood of the observation sequence induced by Xₜ on its time grid:

$$= log {p}_{{x}_{{t}_{1}} , … , {x}_{{t}_{n}}} ( {x}_{{t}_{1}} , … , {x}_{{t}_{n}} ) \qquad ( 8 )$$

In some embodiments, machine learning application 1120 may be configured to model the evolution of a m-dimensional latent state Zₜ in a given time interval using a generic Ito Stochastic Differential Equation driven by an m-dimensional Wiener Process Wₜ:

dZₜ=μ_{θ}(Zₜ,t)dt+σ_{θ}(Zₜ,t)dWₜ (9)

where θ denotes the learnable parameters of the drift μ and variance σ functions. In some embodiments, systems may be configured to implement μ and σ as deep neural networks. The latent state Zₜ may exist for every t in an interval and may be sampled on any given time grid which may be irregular and different for each sequence.

In latent variable models, latent states may be decoded into observable variables with more complex distributions. As the observations are viewed as partial realizations of continuous-time stochastic processes, sample of the latent stochastic process Zₜ may be decoded into continuous trajectories instead of discrete distributions. Based on dynamic normalizing flows models [7, 6, 3], in some embodiments, systems may be configured to provide the observation process as

Xₜ=F_{θ}(Oₜ;Zₜ,t) (10)

where Oₜ is a d-dimensional simple stochastic process such that transition density between two arbitrary time points may be computed in simple closed form and F_{θ}(·; z, t) is a normalizing flow for any z, t.

The above-described example transformation decodes each sample path of Zₜ into a complex distribution of continuous trajectories when Fₑ is a continuous mapping and the sampled trajectories of the base process Oₜ are continuous with respect to time t. Unlike other example systems [7] which may be based on the Wiener process as a base process, embodiments of the present disclosure may utilize the Ornstein-Uhlenbeck (OU) process which has stationary marginal distribution and bounded variance. As a result, the volatility of the observation process may not increase due to the increase of variance in the base process and is primarily determined by the latent process and flow transformations.

In some embodiments, there may be various choices for the concrete realization of the continuously indexed normalizing flows F_{θ}(·; Zₜ, t). Deng et al. [7] discloses a particular case of augmented neural ODE. The transformation may be defined by solving the following initial value problem

$$\frac{d}{d τ} ( \begin{matrix}h ( τ ) \\ a ( τ )\end{matrix} ) = ( \begin{matrix}{f}_{θ} ( h ( τ ) , a ( τ ) , τ ) \\ {g}_{θ} ( a ( τ ) , τ )\end{matrix} ) , ( \begin{matrix}h ( {τ}_{0} ) \\ a ( {τ}_{0} )\end{matrix} ) = ( \begin{matrix}{o}_{t} \\ {( {z}_{t} , t )}^{T}\end{matrix} ) , \qquad ( 11 )$$

and h(τ₁) is taken as the results of the transformation. Cornish et al. [6] discloses a method of continuously indexing normalizing flows based on affine transformations. A basic building block of such model may be defined as

F_{θ}(oₜ;zₜ,t)=f(oₜ·exp(−s(zₜ,t))−u(zₜ,t)) (12)

for some transformations s and u and f is an invertible mapping like a residual flow.

Computing the joint likelihood induced by a stochastic process defined with a SDE on arbitrary time grid may be challenging as there may be few SDEs having a closed-form transition density. Bayesian or numerical approximations may be applied in such scenarios. Embodiments of the present disclosure may include a machine learning application or system configured to approximate the log likelihood of observations with a variational lower bound based on a novel piece-wise construction of the posterior distribution of the latent process.

The likelihood of the observations may be written as the expectation of the conditional likelihood over the latent state Zₜ which may be efficiently evaluated in closed form, i.e.,

$$\begin{matrix}= log {p}_{{x}_{{t}_{1}} , … , {x}_{{t}_{n}}} ( {x}_{{t}_{1}} , … , {x}_{{t}_{n}} ) \\ = log {ω ∼ P}_{} [ {p}_{{x}_{{t}_{1}} , … , {x}_{{t}_{n}} \vert {Z}_{t}} ( {x}_{{t}_{1}} , … , {x}_{{t}_{n}} \vert {Z}_{t} ( ω ) ) ] \\ = log {ω ∼ P}_{} [ {\prod }_{i = 1}^{n} {p}_{{x}_{{t}_{i}} \vert {x}_{{t}_{i - 1}} , {Z}_{{t}_{i}} , {Z}_{{t}_{i - 1}}} ( {x}_{{t}_{i}} \vert {x}_{{t}_{i - 1}} , {Z}_{{t}_{i}} ( ω ) , {Z}_{{t}_{i - 1}} ( ω ) ) ]\end{matrix} \qquad ( 13 )$$

where P is the measure of a standard Wiener process and Zₜ(ω) denotes the sample trajectory of Zₜ driven by ω, a realization of Wiener process. In some scenarios, it may be assumed that t₀=0 and Zₜ_{₀} and Xₜ_{₀} are constant for simplicity. As a result of invertible mapping, the conditional likelihood terms [symbol] may be computed using change of variable formula as follows:

$$log {p}_{{X}_{{t}_{i}} \vert {X}_{{t}_{i - 1}} , {Z}_{{t}_{i}} , {Z}_{{t}_{i - 1}}} ( {x}_{{t}_{i}} \vert {x}_{{t}_{i - 1}} , {Z}_{{t}_{i}} ( ω ) , \\ {Z}_{{t}_{i - 1}} ( ω ) ) = log {p}_{{o}_{{t}_{i}} \vert {o}_{{t}_{i - 1}}} ( {o}_{{t}_{i}} \vert {o}_{{t}_{i - 1}} ) - log \vert det \frac{\partial {F}_{θ} ( {o}_{{t}_{i}} ; {t}_{i} , {Z}_{{t}_{i}} ( ω ) )}{\partial {o}_{{t}_{i}}} \vert \qquad ( 14 )$$

where oₜ_{ᵢ}=F⁻¹(xₜ_{ᵢ}; tᵢ, Zₜ_{ᵢ}(ω)).

In some scenarios, the machine learning application 1120 may be configured to directly take the expectation over latent state Zₜ, which may be computationally intractable. Accordingly, in some embodiments, systems may be configured to use variational approximations of the observation log likelihood for training and density estimation. Good variational approximation results may rely on variational posteriors close enough to the true posterior of latent state conditioned on observations.

In some scenarios, the machine learning application 1120 may be configured to use a single stochastic differential equation to propose the variational posterior, which may imply that the posterior process is still restricted to be a Markov process. Instead, in some embodiments, systems may be configured with a method that is naturally adapted to different time grid, and that may define variational posterior of latent state Zₜ_{ᵢ} not constrained by the Markov property of SDE through further decomposing the log likelihood of observation.

In some embodiments, decomposition may be based on the stationary and independent increment property of Wiener process, i.e., Wₛ₊ₜ−Wₛ behaves like the Wiener process Wₜ. For example, let (Ωⁱ, [symbol] ₜ_{ᵢ}₋ₜ_{_{i−1}}ⁱ, Pⁱ) for i from 1 to n be a series of probability space on which n independent m-dimensional Wiener process Wₜⁱ are defined. Systems may be configured to sample an entire trajectory of Wiener process defined in the interval from 0 to T through sampling independent trajectories of length tᵢ−tᵢ₋₁ from Ifs and adding them on top of each other: ωₜ=Σ_{{i:t}_{ᵢ}_{<t}} ωₜ_{ᵢ}₋ₜ_{_{i−1}}ⁱ+ωₜ₋ₜ_{_{i*−1}}^{i*} where i*=arg max{i:tᵢ<t}+1.

As a result, in some embodiments, the machine learning application 1120 may be configured to solve the latent stochastic differential equations in a piece-wise manner. For example, Zₜ_{ᵢ} may be determined by solving the following stochastic differential equation

d\hat{Z}ₜ=μ_{θ}(\hat{Z}ₜ,t+tᵢ₋₁)dt+σ_{θ}(\hat{Z}ₜ,t+tᵢ₋₁)dWₜⁱ (15)

with Zₜ_{_{i−1}} being the initial value. The log likelihood of observations may be rewritten as

[symbol]

=log [symbol] _{ω}_{¹}_{, . . . ω}_{ⁿ}_{˜P}_{¹}_{× . . . ×P}_{ⁿ}[Åᵢ₌₁ⁿp(xₜ_{ᵢ}|xₜ_{_{i−1}},zₜ_{ᵢ},zₜ_{_{i−1}},ωⁱ)]=log [symbol] _{ω}_{¹}_{˜P}_{¹}[p(xₜ_{₁}|xₜ_{₀},zₜ_{₁},zₜ_{₀},ω¹) . . . [symbol] _{ω}_{ⁱ}_{˜P}_{ⁱ}[p(xₜ_{ᵢ}|xₜ_{_{i−1}},zₜ_{ᵢ},zₜ_{_{i−1}},ωⁱ) [symbol] _{ω}_{ⁱ⁺¹}_{˜P}_{ⁱ⁺¹}[ . . . ]]] (16)

In the present example, the subscripts of p may not be included for simplicity of notation. For each i and expectation term [symbol] _{ω}_{ⁱ}_{˜P}_{ⁱ}[p(xₜ_{ᵢ}|xₜ_{_{i−1}},zₜ_{ᵢ},zₜ_{_{i−1}},ωⁱ) [symbol] _{ω}_{ⁱ⁺¹}_{˜P}_{ⁱ⁺¹}[·]], a posterior SDE may be introduced:

d\tilde{Z}ₜ=μ_{ϕ}_{ᵢ}(\tilde{Z}ₜ,t+tᵢ₋₁)dt+σ_{θ}(\tilde{Z}ₜ,t+tᵢ₋₁)dWₜⁱ (17)

Through sampling \tilde{z} from the posterior SDE, the expectation may be rewritten as

[symbol]

_{ω}_{ⁱ}_{˜P}_{ⁱ}[p(xₜ_{ᵢ}|xₜ_{_{i−1}},\tilde{z}ₜ_{ᵢ},zₜ_{_{i−1}},ωᵢ)Mⁱ(ωⁱ) [symbol] _{∩}_{ᵢ₊₁}_{˜P}_{ᵢ₊₁}[·]] (18)

where

$${M}^{i} = exp ( - {\int }_{0}^{{t}_{i} - {t}_{i - 1}} \frac{1}{2} {\vert u ( {\tilde{Z}}_{s} , s ) \vert}^{2} ds - {\int }_{0}^{{t}_{i} - {t}_{i - 1}} {u ( {\tilde{Z}}_{s} , s )}^{T} {dW}_{s}^{i} )$$

may serve as a re-weighting term for the sampled trajectory between the prior latent SDE and posterior latent SDE and u satisfies σ_{θ}(z, s+tᵢ₋₁)u(z, s)=μ_{ϕ}_{ᵢ}(z, s+tᵢ₋₁)−μ_{θ}(z, s+tᵢ₋₁). Through defining and sampling latent state from a posterior latent SDE for each time interval, embodiments of systems disclosed in the present application may determine the Evidence Lower Bound (ELBO) of the log likelihood

[symbol]

=log [symbol] _{ω}_{¹}_{˜P}_{¹}[p(xₜ_{₁}|xₜ_{₀},\tilde{z}ₜ_{₁},\tilde{z}ₜ_{₀},ω¹)M₁ . . . [symbol] _{ω}_{ⁱ}_{˜P}_{ⁱ}[p(xₜ_{ᵢ}|xₜ_{_{i−1}},\tilde{z}ₜ_{ᵢ},\tilde{z}ₜ_{_{i−1}},ωⁱ)Mⁱ . . . ]]=log [symbol] _{ω}_{¹}_{, . . . ω}_{ⁿ}_{˜P}_{¹}_{× . . . ×P}_{ⁿ}[Πᵢ₌₁ⁿp(xₜ_{ᵢ}|xₜ_{_{i−1}},\tilde{z}ₜ_{ᵢ},\tilde{z}ₜ_{_{i−1}},ωⁱ)Mⁱ(ωⁱ)]≥ [symbol] _{ω}_{¹}_{, . . . ω}_{ⁿ}_{˜P}_{¹}_{× . . . ×P}_{ⁿ}[Σᵢ₌₁ⁿ log p(xₜ_{ᵢ}|xₜ_{_{i−1}},\tilde{z}ₜ_{ᵢ},\tilde{z}ₜ_{_{i−1}},ωⁱ)+Σᵢ₌₁ⁿ log Mⁱ(ωⁱ)] (19)

The bound above may be further extended into a tighter bound in IWAE form by drawing multiple independent samples of each Wᵢ.

In some examples, the machine learning application 1120 may be configured such that the variational parameter ϕᵢ is the output of an encoder RNN that takes the sequence of observations up to tᵢ, {Xₜ_{₁}, . . . , Xₜ_{ᵢ}} and the sequence of previously sampled latent state, i.e. {Zₜ_{₁}, . . . , Zₜ_{_{t−1}}}, as inputs. As a result, the variational posterior distributions of latent states Zₜ_{ᵢ} may no longer be constrained to be Markov and the parameterization of the variational posterior can be adapted flexibly to different time grids.

Experiments were conducted for comparing embodiment system architectures and models with one or more baseline models for irregular time-series data, including CTFP, latent CTFP, and latent SDE.

In some experiments, embodiments of systems were configured with models fit to data sampled from the following stochastic processes:

Geometric Brownian Motion: dXₜ=μXₜdt+σXₜdWₜ.

Experiments demonstrate that even though geometric Brownian motion may theoretically be captured by the CTFP model, it would require the normalizing flow to be non-Lipschitz. In contrast, there may be no such constraint for the proposed model.

Gauss-Markov Process: dXₜ=(a(t)Xₜ+b(t))dt+σdWₜ.

An application of Itô's lemma shows that the Gauss-Markov process may be a stochastic process that cannot be captured by the CTFP model.

Stochastic Lorenz Curve: Experiments based on this process were for demonstrating embodiments of the model disclosed herein and the model's ability to capture multi-dimensional data. A three-dimensional Lorenz curve may be defined by the stochastic differential equations

dXₜ=σ(Yₜ−Xₜ)dt+αₓdWₜ,

dYₜ=(Xₜ(ρ−Zₜ)−Yₜ)dt+α_{y}dWₜ,

dZₜ=(XₜYₜ−βZₜ)dt+α_{z}dWₜ. (20)

Continuous AR(4) Process. An example Continuous AR(4) Process may test embodiments disclosed herein on its ability to capture non-Markov processes. The AR(4) process may be characterized by the stochastic process:

Xₜ=[d,0,0,0]Yₜ,

dYₜ=AYₜdt+edWₜ, (21)

where

$$A = [ \begin{matrix}0 & 1 & 0 & 0 \\ 0 & 0 & 1 & 0 \\ 0 & 0 & 0 & 1 \\ {a}_{1} & {a}_{2} & {a}_{3} & {a}_{4}\end{matrix} ] , e = {[ 0 , 0 , 0 , 1 ]}^{T} . \qquad ( 22 )$$

In some scenarios, systems were configured to sample the observation time stamps from a homogeneous Poisson process with rate λ. To demonstrate embodiments of models disclosed in the present application and their ability to generalize to different time grids, evaluations were made based on different rates λ. An approximate numerical solution to SDEs may be obtained using the Euler-Maruyama scheme for the Itô integral.

Referring back to FIG. 1, System 100 includes an I/O unit 102, a processor 104, a communication interface 106, and a data storage 120.

I/O unit 102 enables system 100 to interconnect with one or more input devices, such as a keyboard, mouse, camera, touch screen and a microphone, sensors 160, and/or with one or more output devices such as a display screen and a speaker.

Processor 104 executes instructions stored in memory 108 to implement aspects of processes described herein. For example, processor 104 may execute instructions in memory 108 to configure a data collection unit, interface unit (to provide control commands to interface application 130), neural network 110, machine learning application 112, machine learning engine 116, and other functions described herein.

Processor 104 can be, for example, various types of general-purpose microprocessor or microcontroller, a digital signal processing (DSP) processor, an integrated circuit, a field programmable gate array (FPGA), a reconfigurable processor, or any combination thereof.

Communication interface 106 enables system 100 to communicate with other components, to exchange data with other components, to access and connect to network resources, to serve applications, and perform other computing applications by connecting to a network 140 (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g., Wi-Fi or WiMAX), SS7 signaling network, fixed line, local area network, wide area network, and others, including any combination of these.

Data storage 120 can include memory 108, databases 122, and persistent storage 124. Data storage 120 may be configured to store information associated with or created by the components in memory 108 and may also include machine executable instructions. Persistent storage 124 implements one or more of various types of storage technologies, such as solid state drives, hard disk drives, flash memory, and may be stored in various formats, such as relational databases, non-relational databases, flat files, spreadsheets, extended markup files, etc.

Data storage 120 stores a model fora machine learning neural network 110. The neural network 110 is used by a machine learning application 1120 to generate one or more predicted data values based on a time series data 112.

Memory 108 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like.

System 100 may connect to an interface application 130 installed on a user device to receive user data. The interface unit 130 interacts with the system 100 to exchange data (including control commands) and generates visual elements for display at the user device. The visual elements can represent machine learning networks 110 and output generated by machine learning networks 110.

System 100 may be operable to register and authenticate users (using a login, unique identifier, and password for example) prior to providing access to applications, a local network, network resources, other networks and network security devices.

System 100 may connect to different data sources including sensors 160 and databases 170 to store and retrieve input data and output data.

Processor 104 is configured to execute machine executable instructions (which may be stored in memory 108) to maintain a neural network 110, and to train neural network 110 of using machine learning engine 116. The machine learning engine 116 may implement various machine learning algorithms, such as latent ODE model, CTFP model, or other suitable networks.

Reference is made to FIG. 1B, which illustrates a system 1000 for machine learning architecture, in accordance with some embodiments of the present disclosure. The system 1000 may transmit and/or receive data messages to/from a client device 1100 via a network 140. The network 140 may include a wired or wireless wide area network (WAN), local area network (LAN), a combination thereof, or the like.

The system 1000 includes a processor 1020 configured to execute processor-readable instructions that, when executed, configure the processor 1020 to conduct operations described herein. For example, the system 1000 may be configured to conduct operations for time series data prediction, in accordance with embodiments of the present disclosure.

The processor 1020 may be a microprocessor or microcontroller, a digital signal processing (DSP) processor, an integrated circuit, a field programmable gate array (FPGA), a reconfigurable processor, a programmable read-only memory (PROM), or combinations thereof.

The system 1000 includes a communication circuit 1040 to communicate with other computing devices, to access or connect to network resources, or to perform other computing applications by connecting to a network (or multiple networks) capable of carrying data.

In some embodiments, the network 140 may include the Internet, Ethernet, plain old telephone service line, public switch telephone network, integrated services digital network, digital subscriber line, coaxial cable, fiber optics, satellite, mobile, wireless, SS7 signaling network, fixed line, local area network, wide area network, and others, including combination of these.

In some examples, the communication circuit 1040 may include one or more busses, interconnects, wires, circuits, and/or any other connection and/or control circuit, or combination thereof. The communication circuit 1040 may provide an interface for communicating data between components of a single device or circuit.

The system 1000 may include memory 1060. The memory 1060 may include one or a combination of computer memory, such as static random-access memory, random-access memory, read-only memory, electro-optical memory, magneto-optical memory, erasable programmable read-only memory, electrically-erasable programmable read-only memory, Ferroelectric RAM or the like.

The memory 1060 may store a machine learning application 1120 including processor readable instructions for conducting operations described herein. In some embodiments, the machine application 1120 may include operations for time series data prediction. Other example operations may be contemplated and are disclosed herein.

The system 1000 may include a data storage 1140. In some embodiments, the data storage 1140 may be a secure data store. In some embodiments, the data storage 1140 may store input data sets, such as time series data, training data sets, image data or the like.

The client device 1100 may be a computing device including a processor, memory, and a communication interface. In some embodiments, the client device 1100 may be a computing device associated with a local area network. The client device 1100 may be connected to the local area network and may transmit one or more data sets, via the network 140, to the system 1000. The one or more data sets may be input data, such that the system 1000 may conduct one or more operations associated with likelihood determination, data sampling, data interpolation, or data extrapolation. Other operations may be contemplated, as described in the present disclosure.

In some embodiments, the system 1000 may include machine learning architecture having operations to configure a processor to conduct flow-based decoding of a generic stochastic differential equation as a principled framework for continuous dynamics modeling from irregular time-series data.

In some embodiments, the system 1000 may be configured to conduct variational approximation of observational likelihood associated with a non-Markovian posterior-process based on a piece-wise evaluation of the underlying stochastic differential equation.

In some embodiments, systems may be configured to provide a Latent SDE Flow Process described herein. Let {(xₜ_{ᵢ}, tᵢ)}ᵢ₌₁ⁿ, denote a sequence of d-dimensional observations sampled on a given time grid where tᵢ denotes the time stamp of the observation and xₜ_{ᵢ} is the observation's value. The observations may be partial realizations of a continuous-time stochastic processes Xₜ. Systems may be configured to maximize the log likelihood of the observation sequence induced by Xₜ on its time grid:

$$= log {p}_{{x}_{{t}_{1}} , … , {x}_{{t}_{n}}} ( {x}_{{t}_{1}} , … , {x}_{{t}_{n}} ) \qquad ( 8 )$$

In some embodiments, systems may be configured to model the evolution of a m-dimensional latent state Zₜ in a given time interval using a generic Ito Stochastic Differential Equation driven by an m-dimensional Wiener Process Wₜ:

dZₜ=μ_{θ}(Zₜ,t)dt+σ_{θ}(Zₜ,t)dWₜ (9)

where θ denotes the learnable parameters of the drift μ and variance σ functions. In some embodiments, systems may be configured to implement μ and σ as deep neural networks. The latent state Zₜ may exist for every t in an interval and may be sampled on any given time grid which may be irregular and different for each sequence.

In latent variable models, latent states may be decoded into observable variables with more complex distributions. As the observations are viewed as partial realizations of continuous-time stochastic processes, sample of the latent stochastic process Zₜ may be decoded into continuous trajectories instead of discrete distributions. Based on dynamic normalizing flows models [7, 6, 3], in some embodiments, systems may be configured to provide the observation process as

Xₜ=F_{θ}(Oₜ;Zₜ,t) (10)

where Oₜ is a d-dimensional simple stochastic process such that transition density between two arbitrary time points may be computed in simple closed form and F_{θ}(·; z, t) is a normalizing flow for any z, t.

The above-described example transformation decodes each sample path of Zₜ into a complex distribution of continuous trajectories when F_{θ} is a continuous mapping and the sampled trajectories of the base process Oₜ are continuous with respect to time t. Unlike other example systems [7] which may be based on the Wiener process as a base process, embodiments of the present disclosure may utilize the Ornstein-Uhlenbeck (OU) process which has stationary marginal distribution and bounded variance. As a result, the volatility of the observation process may not increase due to the increase of variance in the base process and is primarily determined by the latent process and flow transformations.

In some embodiments, there may be various choices for the concrete realization of the continuously indexed normalizing flows F_{θ}(·; Zₜ, t). Deng et al. [7] discloses a particular case of augmented neural ODE. The transformation may be defined by solving the following initial value problem

$$\frac{d}{d τ} ( \begin{matrix}h ( τ ) \\ a ( τ )\end{matrix} ) = ( \begin{matrix}{f}_{θ} ( h ( τ ) , a ( τ ) , τ ) \\ {g}_{θ} ( a ( τ ) , τ )\end{matrix} ) , ( \begin{matrix}h ( {τ}_{0} ) \\ a ( {τ}_{0} )\end{matrix} ) = ( \begin{matrix}{o}_{t} \\ {( {z}_{t} , t )}^{T}\end{matrix} ) , \qquad ( 11 )$$

and h(τ₁) is taken as the results of the transformation. Cornish et al. [6] discloses a method of continuously indexing normalizing flows based on affine transformations. A basic building block of such model may be defined as

F_{θ}(oₜ;zₜ,t)=f(oₜ·exp(−s(zₜ,t))−u(zₜ,t)) (12)

for some transformations s and u and f is an invertible mapping like a residual flow.

Computing the joint likelihood induced by a stochastic process defined with a SDE on arbitrary time grid may be challenging as there may be few SDEs having a closed-form transition density. Bayesian or numerical approximations may be applied in such scenarios. Embodiments of the present disclosure may include systems configured to approximate the log likelihood of observations with a variational lower bound based on a novel piece-wise construction of the posterior distribution of the latent process.

The likelihood of the observations may be written as the expectation of the conditional likelihood over the latent state Zₜ which may be efficiently evaluated in closed form, i.e.,

$$\begin{matrix}= log {p}_{{x}_{{t}_{1}} , … , {x}_{{t}_{n}}} ( {x}_{{t}_{1}} , … , {x}_{{t}_{n}} ) \\ = log {ω ∼ P}_{} [ {p}_{{x}_{{t}_{1}} , … , {x}_{{t}_{n}} \vert {Z}_{t}} ( {x}_{{t}_{1}} , … , {x}_{{t}_{n}} \vert {Z}_{t} ( ω ) ) ] \\ = log {ω ∼ P}_{} [ {\prod }_{i = 1}^{n} {p}_{{x}_{{t}_{i}} \vert {x}_{{t}_{i - 1}} , {Z}_{{t}_{i}} , {Z}_{{t}_{i - 1}}} ( {x}_{{t}_{i}} \vert {x}_{{t}_{i - 1}} , {Z}_{{t}_{i}} ( ω ) , {Z}_{{t}_{i - 1}} ( ω ) ) ]\end{matrix} \qquad ( 13 )$$

where P is the measure of a standard Wiener process and Zₜ(ω) denotes the sample trajectory of Zₜ driven by ω, a realization of Wiener process. In some scenarios, it may be assumed that t₀=0 and Zₜ_{₀} and Xₜ_{₀} are constant for simplicity. As a result of invertible mapping, the conditional likelihood terms [symbol] may be computed using change of variable formula as follows:

$$log {p}_{{X}_{{t}_{i}} \vert {X}_{{t}_{i - 1}} , {Z}_{{t}_{i}} , {Z}_{{t}_{i - 1}}} ( {x}_{{t}_{i}} \vert {x}_{{t}_{i - 1}} , {Z}_{{t}_{i}} ( ω ) , \\ {Z}_{{t}_{i - 1}} ( ω ) ) = log {p}_{{o}_{{t}_{i}} \vert {o}_{{t}_{i - 1}}} ( {o}_{{t}_{i}} \vert {o}_{{t}_{i - 1}} ) - log \vert det \frac{\partial {F}_{θ} ( {o}_{{t}_{i}} ; {t}_{i} , {Z}_{{t}_{i}} ( ω ) )}{\partial {o}_{{t}_{i}}} \vert \qquad ( 14 )$$

where oₜ_{ᵢ}=F⁻¹(xₜ_{ᵢ}; tᵢ, Zₜ_{ᵢ}(ω)).

In some scenarios, systems may be configured to directly take the expectation over latent state Zₜ, which may be computationally intractable. Accordingly, in some embodiments, systems may be configured to use variational approximations of the observation log likelihood for training and density estimation. Good variational approximation results may rely on variational posteriors close enough to the true posterior of latent state conditioned on observations.

In some scenarios, systems may be configured to use a single stochastic differential equation to propose the variational posterior, which may imply that the posterior process is still restricted to be a Markov process. Instead, in some embodiments, systems may be configured with a method that is naturally adapted to different time grid, and that may define variational posterior of latent state Zₜ_{ᵢ} not constrained by the Markov property of SDE through further decomposing the log likelihood of observation.

In some embodiments, decomposition may be based on the stationary and independent increment property of Wiener process, i.e., Wₛ₊ₜ−Wₛ behaves like the Wiener process Wₜ. For example, let (Ωⁱ, [symbol] ₜ_{ᵢ}₋ₜ_{_{t−1}}ⁱ, Pⁱ) for i from 1 to n be a series of probability space on which n independent m-dimensional Wiener process Wₜⁱ are defined. Systems may be configured to sample an entire trajectory of Wiener process defined in the interval from 0 to T through sampling independent trajectories of length tᵢ−tᵢ₋₁ from Ifs and adding them on top of each other: ωₜ=Σ_{{i:t}_{ᵢ}_{<t}}ωₜ_{ᵢ}₋ₜ_{_{i−1}}ⁱ+ωₜ₋ₜ_{_{i*−1}}^{i*} where i*=arg max{i: tᵢ<t}+1.

As a result, in some embodiments, systems may be configured to solve the latent stochastic differential equations in a piece-wise manner. For example, Zₜ_{ᵢ} may be determined by solving the following stochastic differential equation

d\tilde{Z}ₜ=μ_{θ}(\hat{Z}ₜ,t+tᵢ₋₁)dt+σ_{θ}(\hat{Z}ₜ,t+tᵢ₋₁)dWₜⁱ (15)

with Zₜ_{_{i−1}} being the initial value. The log likelihood of observations may be rewritten as

[symbol]

=log [symbol] _{ω}_{¹}_{, . . . ω}_{ⁿ}_{˜P}_{¹}_{× . . . ×P}_{ⁿ}[Πᵢ₌₁ⁿ(xₜ_{_{i−1}},zₜ_{ᵢ},zₜ_{_{i−1}},ωⁱ)]=log [symbol] _{ω}_{ⁱ}_{˜P}_{¹}[p(xₜ_{ᵢ}|xₜ_{₀},zₜ_{₁},zₜ_{₀},ω¹) . . . [symbol] _{ω}_{ⁱ}_{˜P}_{ⁱ}[p(xₜ_{_{i−1}},zₜ_{ᵢ},zₜ_{_{i−1}},ωⁱ) [symbol] _{ω}_{ⁱ⁺¹}_{˜P}_{ⁱ⁺¹}[ . . . ]]] (16)

In the present example, the subscripts of p may not be included for simplicity of notation. For each i and expectation term [symbol] _{ω}_{ⁱ}_{˜P}_{ⁱ}[p(xₜ_{ᵢ}|xₜ_{_{i−1}},zₜ_{ᵢ},zₜ_{_{i−1}},ωⁱ) [symbol] _{ω}_{ⁱ⁺¹}_{˜P}_{ⁱ⁺¹}[·]], a posterior SDE may be introduced:

d\tilde{Z}ₜ=μ_{ϕ}_{ᵢ}(\tilde{Z}ₜ,t+tᵢ₋₁)dt+σ_{θ}(\tilde{Z}ₜ,t+tᵢ₋₁)dWₜⁱ (17)

Through sampling \tilde{z} from the posterior SDE, the expectation may be rewritten as)

[symbol]

_{ω}_{ⁱ}_{˜P}_{ⁱ}[p(xₜ_{ᵢ}|xₜ_{_{i−1}},\tilde{z}ₜ_{ᵢ},zₜ_{_{i−1}},ωᵢ)Mⁱ(ωⁱ) [symbol] _{ω}_{ᵢ₊₁}_{˜P}_{ᵢ₊₁}[˜]] (18)

where

$${M}^{i} = exp ( - {\int }_{0}^{{t}_{i} - {t}_{i - 1}} \frac{1}{2} {\vert u ( {\tilde{Z}}_{s} , s ) \vert}^{2} ds - {\int }_{0}^{{t}_{i} - {t}_{i - 1}} {u ( {\tilde{Z}}_{s} , s )}^{T} {dW}_{s}^{i} )$$

may serve as a re-weighting term for the sampled trajectory between the prior latent SDE and posterior latent SDE and u satisfies σ_{θ}(z, s+tᵢ₋₁)u(z, s)=μ_{ϕ}_{ᵢ}(z, s+tᵢ₋₁)−μ_{θ}(z, s+tᵢ₋₁). Through defining and sampling latent state from a posterior latent SDE for each time interval, embodiments of systems disclosed in the present application may determine the Evidence Lower Bound (ELBO) of the log likelihood

[symbol]

=log [symbol] _{ω}_{¹}_{˜P}_{¹}[p(xₜ_{₁}|xₜ_{₀},\tilde{z}ₜ_{₁},\tilde{z}ₜ_{₀},ω¹)M₁ . . . [symbol] _{ω}_{ⁱ}_{˜P}_{ⁱ}[p(xₜ_{ᵢ}|xₜ_{_{i−1}},\tilde{z}ₜ_{ᵢ},\tilde{z}ₜ_{_{i−1}},ωⁱ)Mⁱ . . . ]]=log [symbol] _{ω}_{¹}_{, . . . ω}_{ⁿ}_{˜P}_{¹}_{× . . . ×P}_{ⁿ}[Πᵢ₌₁ⁿp(xₜ_{ᵢ}|xₜ_{_{i−1}},\tilde{z}ₜ_{ᵢ},\tilde{z}ₜ_{_{i−1}},ωⁱ)Mⁱ(ωⁱ)]≥ [symbol] _{ω}_{¹}_{, . . . ω}_{ⁿ}_{˜P}_{¹}_{× . . . ×P}_{ⁿ}[Σᵢ₌₁ⁿ log p(xₜ_{ᵢ}|xₜ_{_{i−1}},\tilde{z}ₜ_{ᵢ},\tilde{z}ₜ_{_{i−1}},ωⁱ)+Σᵢ₌₁ⁿ log Mⁱ(ωⁱ)] (19)

The bound above may be further extended into a tighter bound in IWAE form by drawing multiple independent samples of each W₁.

In some examples, systems may be configured such that the variational parameter ϕᵢ is the output of an encoder RNN that takes the sequence of observations up to tᵢ, {Xₜ_{₁}, . . . , Xₜ_{ᵢ}} and the sequence of previously sampled latent state, i.e. {Zₜ_{₁}, . . . , Zₜ_{_{i−1}}}, as inputs. As a result, the variational posterior distributions of latent states Zₜ_{ᵢ} may no longer be constrained to be Markov and the parameterization of the variational posterior can be adapted flexibly to different time grids.

Experiments were conducted for comparing embodiment system architectures and models with one or more baseline models for irregular time-series data, including CTFP, latent CTFP, and latent SDE.

In some experiments, embodiments of systems were configured with models fit to data sampled from the following stochastic processes:

Geometric Brownian Motion: dXₜ=μXₜdt+σXₜdWₜ.

Experiments demonstrate that even though geometric Brownian motion may theoretically be captured by the CTFP model, it would require the normalizing flow to be non-Lipschitz. In contrast, there may be no such constraint for the proposed model.

Gauss-Markov Process: dXₜ=(a(t)Xₜ+b(t))dt+σdWₜ.

An application of Itô's lemma shows that the Gauss-Markov process may be a stochastic process that cannot be captured by the CTFP model.

Stochastic Lorenz Curve: Experiments based on this process were for demonstrating embodiments of the model disclosed herein and the model's ability to capture multi-dimensional data. A three-dimensional Lorenz curve may be defined by the stochastic differential equations

dXₜ=σ(Yₜ−Xₜ)dt+αₓdWₜ,

dYₜ=(Xₜ(ρ−Zₜ)−Yₜ)dt+α_{y}dWₜ,

dZₜ=(XₜYₜ−βZₜ)dt+α_{z}dWₜ. (20)

Continuous AR(4) Process. An example Continuous AR(4) Process may test embodiments disclosed herein on its ability to capture non-Markov processes. The AR(4) process may be characterized by the stochastic process:

Xₜ=[d,0,0,0]Yₜ,

dYₜ=AYₜdt+edWₜ, (21)

where

$$A = [ \begin{matrix}0 & 1 & 0 & 0 \\ 0 & 0 & 1 & 0 \\ 0 & 0 & 0 & 1 \\ {a}_{1} & {a}_{2} & {a}_{3} & {a}_{4}\end{matrix} ] , e = {[ 0 , 0 , 0 , 1 ]}^{T} . \qquad ( 22 )$$

In some scenarios, systems were configured to sample the observation time stamps from a homogeneous Poisson process with rate λ. To demonstrate embodiments of models disclosed in the present application and their ability to generalize to different time grids, evaluations were made based on different rates λ. An approximate numerical solution to SDEs may be obtained using the Euler-Maruyama scheme for the Itô integral.

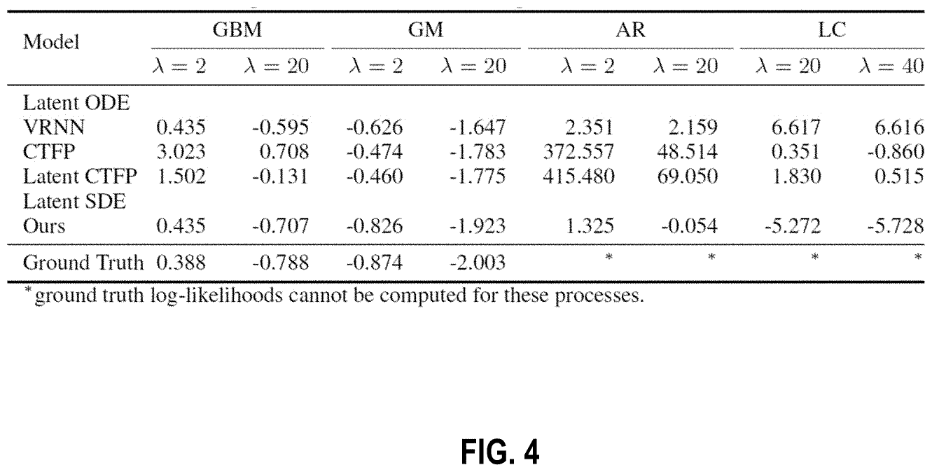

Reference is made to FIG. 4, which is a table representing quantitative evaluation (synthetic data), in a accordance with an embodiment of the present disclosure. FIG. 4 illustrates test negative log-likelihoods of four synthetic stochastic processes based on different models. Below each process, the table indicates the intensity of the Poisson point process from which the timestamps for the test sequences were sampled for testing. “Ground Truth” may refer to the closed-form negative log-likelihood of the true underlying data generation process.

In the table, GBM refers to geometric Brownian motion. GM refers to Gauss-Markov process. AR refers to Auto-regressive process. LC refers to Lorenz curve.

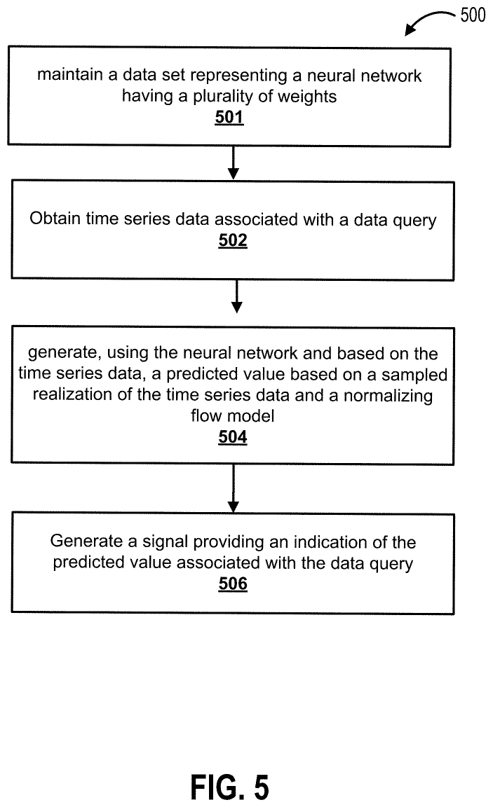

Reference is made to FIG. 5, which illustrates a flowchart of a method 500 for machine learning architecture for time series data prediction, in accordance with embodiments of the present disclosure. The steps are provided for illustrative purposes. Variations of the steps, omission or substitution of various steps, or additional steps may be considered. It should be understood that one or more of the blocks may be performed in a different sequence or in an interleaved or iterative manner.

The method 500 may be conducted by the processor 104 of the system 100 in FIG. 1A or the processor 1020 of the system 1000 in FIG. 1B. Processor-executable instructions may be stored in the memory 108, 1060 and may be associated with the machine learning application 1120 or other processor-executable applications. The method 500 may include operations such as data retrievals, data manipulations, data storage, or other operations, and may include computer-executable operations.

Embodiments disclosed herein may be applicable to natural processes, such as environmental conditions, vehicle travel statistics over time, electricity consumption over time, asset valuation in capital markets, among other examples. In some other examples, generative models disclosed herein may be applied for natural language processing, recommendation systems, traffic pattern prediction, medical data analysis, or other types of forecasting based on irregular time series data. It may be appreciated that embodiments of the present disclosure may be implemented for other types of data sampling or prediction, likelihood density determination, or inference tasks such as interpolation or extrapolation based on irregular time series data sets.

At operation 501, the processor may maintain a data set representing a neural network 110 having a plurality of weights. The data set representing the neural network 110 may be stored, and the weights updated during each training iteration or training cycle.

At operation 502, the processor may obtain time series data 112 associated with a data query. The time series data 112 may represent data sets gathered from one or more sensors 160 or a database 170. For example, the time series data 112 may represent temperature data collected from one or more HVAC sensors, traffic flow data collected from one or more traffic sensors, blood pressure or blood sugar levels collected from one or more medical device sensors.

The data query may be a signal indicating a request to generate a predicted value based on the time series data 112. For example, the data query may be a request to generate a predicted room temperature value at a future time, or a request to generate a predicted traffic flow estimation at a future time.

In some embodiments, the time series data that are used as a basis for prediction may include irregularly spaced temporal data. Irregularly spaced temporal data may be asynchronous data. Asynchronous data may include data points or measurements that do not need to follow a regular pattern (e.g., once per hour); instead, the data points can be arbitrarily spaced.

For instance, the time series data 112 may include an unevenly (or irregularly) spaced data values or data points that form a sequence of timestamp and value pairs (tₙ, Xₙ) in which the spacing of timestamps is not constant. Such unevenly (or irregularly) spaced time series data occurs naturally in many aspects, such as physical world (e.g., floods, volcanic eruptions, astronomy), clinical trials, climatology, and signal processing. The system disclosed in embodiments may use trained machine learning models to make data extrapolation or interpolation based on the irregularly spaced time series data 112. As further described below, data extrapolation may mean that making a value prediction at a future timestamp: taking data values at points x₁, . . . , xₙ within the time series data 112, and approximating a value outside the range of the given points. Data interpolation, on the other hand, may mean a process of using known data values in the time series data 112 to estimate unknown data values between two arbitrary data points within the time series data 112.

At operation 504, the processor may generate, using the neural network 110 and based on the time series data 112, a predicted data value based on a sampled realization of the time series data 112 and a normalizing flow model.

In some embodiments, the predicted value may be a data point in the future (extrapolation).

In some embodiments, the predicted value may be an interpolation between two data points from the time series data. For example, the predicted value may be a data point between two arbitrary points in time between two existing measurements from the time series data.

In some embodiments, the processor may determine the log likelihood of observations with a variational lower bound.

In some embodiments, the variational lower bound is based on a piece-wise construction of a posterior distribution of a latent latent process.

In some embodiments, the normalizing flow model (F_{θ}) is configured to decode a continuous time sample path of a latent state into a complex distribution of continuous trajectories.

In some embodiments, F_{θ} is a continuous mapping and one or more sampled trajectories of the latent continuous-time stochastic process are continuous with respect to time.

In some embodiments, the latent state has m+1 dimensions, and wherein m is derived from the latent continuous-time stochastic process, and the additional one dimension comes from the latent SDE model.

In some embodiments, a variational posterior of the latent state is based on piece-wise solutions of latent differential equations.

In some embodiments, the latent continuous-time stochastic process comprises an Ornstein-Uhlenbeck (OU) process having the stationary marginal distribution and bounded variance.

In some embodiments, the latent continuous-time stochastic process is configured such that transition density between two arbitrary time points is determined in closed form.

At operation 506, the processor may generate a signal providing an indication of the predicted value associated with the data query.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

As can be understood, the examples described above and illustrated are intended to be exemplary only.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

### REFERENCES

All the references cited throughout this disclosure and below are hereby incorporated by reference in entirety.
[1] Cedric Archambeau, Dan Cornford, Manfred Opper, and John Shawe-Taylor. Gaussian process approximations of stochastic differential equations. In Gaussian Processes in Practice, pages 1-16. PMLR, 2007.
[2] Jens Behrmann, Will Grathwohl, Ricky TQ Chen, David Duvenaud, and Joern-Henrik Jacobsen. Invertible residual networks. In International Conference on Machine Learning, pages 573-582,2019.
[3] Anthony Caterini, Rob Cornish, Dino Sejdinovic, and Arnaud Doucet. Variational inference with continuously-indexed normalizing flows. arXiv preprint arXiv:2007.05426, 2020.
[4] Tian Qi Chen, Jens Behrmann, David K Duvenaud, and Jörn-Henrik Jacobsen. Residual flows for invertible generative modeling. In Advances in Neural Information Processing Systems, pages 9913-9923, 2019.
[5] Tian Qi Chen, Yulia Rubanova, Jesse Bettencourt, and David K Duvenaud. Neural ordinary differential equations. In Advances in neural information processing systems, pages 6571-6583, 2018.
[6] Rob Cornish, Anthony Caterini, George Deligiannidis, and Arnaud Doucet. Relaxing bijectivity constraints with continuously indexed normalising flows. In International Conference on Machine Learning, pages 2133-2143. PMLR, 2020.
[7] Ruizhi Deng, Bo Chang, Marcus A Brubaker, Greg Mori, and Andreas Lehrmann. Modeling continuous stochastic processes with dynamic normalizing flows. arXiv preprint arXiv:2002.10516, 2020.
[8] Laurent Dinh, David Krueger, and Yoshua Bengio. NICE: Non-linear independent components estimation. arXiv preprint arXiv:1410.8516, 2014.
[9] Laurent Dinh, Jascha Sohl-Dickstein, and Samy Bengio. Density estimation using Real NVP. In International Conference on Learning Representations, 2017.
[10] Ramazan Gençay, Michel Dacorogna, Ulrich A Muller, Olivier Pictet, and Richard Olsen. An introduction to high-frequency finance. Elsevier, 2001.
[11] Ary L Goldberger, Luis A N Amaral, Leon Glass, Jeffrey M Hausdorff, Plamen Ch Ivanov, Roger G Mark, Joseph E Mietus, George B Moody, Chung-Kang Peng, and H Eugene Stanley. Physiobank, physiotoolkit, and physionet: components of a new research resource for complex physiologic signals. circulation, 101(23):e215—e220, 2000.
[12] Will Grathwohl, Ricky T. Q. Chen, Jesse Bettencourt, and David Duvenaud. Scalable reversible generative models with free-form continuous dynamics. In International Conference on Learning Representations, 2019.
[13] Ali Hasan, João M Pereira, Sina Farsiu, and Vahid Tarokh. Identifying latent stochastic differential equations with variational auto-encoders. stat, 1050:14, 2020.
[14] Priyank Jaini, Ivan Kobyzev, Yaoliang Yu, and Marcus Brubaker. Tails of lipschitz triangular flows. In International Conference on Machine Learning, pages 4673-4681. PMLR, 2020.
[15] Patrick Kidger, James Foster, Xuechen Li, Harald Oberhauser, and Terry Lyons. Neural sdes as infinite-dimensional gans. arXiv preprint arXiv:2102.03657, 2021.
[16] Durk P Kingma and Prafulla Dhariwal. Glow: Generative flow with invertible 1×1 convolutions. In Advances in Neural Information Processing Systems, pages 10215-10224, 2018.
[17] Durk P Kingma, Tim Salimans, Rafal Jozefowicz, Xi Chen, Ilya Sutskever, and Max Welling. Improved variational inference with inverse autoregressive flow. In Advances in neural information processing systems, pages 4743-4751, 2016.
[18] Ivan Kobyzev, Simon Prince, and Marcus A Brubaker. Normalizing flows: Introduction and ideas. arXiv preprint arXiv:1908.09257, 2019.
[19] Xuechen Li, Ting-Kam Leonard Wong, Ricky TQ Chen, and David Duvenaud. Scalable gradients for stochastic differential equations. arXiv preprint arXiv:2001.01328, 2020.
[20] James Morrill, Cristopher Salvi, Patrick Kidger, James Foster, and Terry Lyons. Neural rough differential equations for long time series. arXiv preprint arXiv:2009.08295, 2020.
[21] Bernt Oksendal. Stochastic differential equations: an introduction with applications. Springer Science & Business Media, 2013.
[22] George Papamakarios, Eric Nalisnick, Danilo Jimenez Rezende, Shakir Mohamed, and Balaji Lakshminarayanan. Normalizing flows for probabilistic modeling and inference. arXiv preprint arXiv:1912.02762, 2019.
[23] George Papamakarios, Theo Pavlakou, and lain Murray. Masked autoregressive flow for density estimation. In Advances in Neural Information Processing Systems, pages 2338-2347, 2017.

What is claimed is:

1. A system for machine learning architecture for time series data prediction comprising:
a processor; and
a memory coupled to the processor and storing processor-executable instructions that, when executed, configure the processor to:
maintain a data set representing a neural network having a plurality of weights;
obtain time series data associated with a data query;
generate, using the neural network and based on the time series data, a predicted value based on a sampled realization of the time series data and a normalizing flow model, the normalizing flow model based on a latent continuous-time stochastic process having a stationary marginal distribution and bounded variance; and
generate a signal providing an indication of the predicted value associated with the data query.

2. The system of claim 1, wherein the memory includes processor-executable instructions that, when executed, configure the processor to determine a log likelihood of observations with a variational lower bound.

3. The system of claim 2, wherein the variational lower bound is based on a piece-wise construction of a posterior distribution of a latent continuous-time stochastic process.

4. The system of claim 1, wherein the normalizing flow model (F_{θ}) is configured to decode a continuous time sample path of a latent state into a complex distribution of continuous trajectories.

5. The system of claim 3, wherein F₉ is a continuous mapping and one or more sampled trajectories of the latent continuous-time stochastic process are continuous with respect to time.

6. The system of claim 4, wherein the latent state has m+1 dimensions, and wherein m is derived from the latent continuous-time stochastic process.

7. The system of claim 3, wherein a variational posterior of the latent state is based on piece-wise solutions of latent differential equations.

8. The system of claim 1, wherein the latent continuous-time stochastic process comprises an Ornstein-Uhlenbeck (OU) process having the stationary marginal distribution and bounded variance.

9. The system of claim 1, wherein the latent continuous-time stochastic process is configured such that transition density between two arbitrary time points is determined in closed form.

10. The system of claim 1, wherein the time series data comprises sensor data obtained from one or more physical sensor devices.

11. The system of claim 1, wherein the time series data comprises irregularly spaced temporal data.

12. The system of claim 1, wherein the predicted value comprises an interpolation between two data points from the time series data.

13. A computer-implemented method for machine learning architecture for time series data prediction comprising:
maintaining a data set representing a neural network having a plurality of weights;
obtaining time series data associated with a data query;
generating, using the neural network and based on the time series data, a predicted value based on a sampled realization of the time series data and a normalizing flow model, the normalizing flow model based on a latent continuous-time stochastic process having a stationary marginal distribution and bounded variance; and
generating a signal providing an indication of the predicted value associated with the data query.

14. The method of claim 13, further comprising determining a log likelihood of observations with a variational lower bound.

15. The method of claim 14, wherein the variational lower bound is based on a piece-wise construction of a posterior distribution of a latent latent process.

16. The method of claim 13, wherein the normalizing flow model (F_{θ}) is configured to decode a continuous time sample path of a latent state into a complex distribution of continuous trajectories.

17. The method of claim 15, wherein F₉ is a continuous mapping and one or more sampled trajectories of the latent continuous-time stochastic process are continuous with respect to time.

18. The method of claim 16, wherein the latent state has m+1 dimensions, and wherein m is derived from the latent continuous-time stochastic process.

19. The method of claim 15, wherein a variational posterior of the latent state is based on piece-wise solutions of latent differential equations.

20. The method of claim 13, wherein the latent continuous-time stochastic process comprises an Ornstein-Uhlenbeck (OU) process having the stationary marginal distribution and bounded variance.

21. The method of claim 13, wherein the latent continuous-time stochastic process is configured such that transition density between two arbitrary time points is determined in closed form.

22. The method of claim 13, wherein the time series data comprises sensor data obtained from one or more physical sensor devices.

23. The method of claim 13, wherein the time series data comprises irregularly spaced temporal data.

24. The method of claim 13, wherein the predicted value comprises an interpolation between two data points from the time series data.

25. A non-transitory computer-readable medium having stored thereon machine interpretable instructions which, when executed by a processor, cause the processor to perform a computer-implemented method for machine learning architecture for time series data prediction, the method comprising:
maintaining a data set representing a neural network having a plurality of weights;
obtaining time series data associated with a data query;
generating, using the neural network and based on the time series data, a predicted value based on a sampled realization of the time series data and a normalizing flow model, the normalizing flow model based on a latent continuous-time stochastic process having a stationary marginal distribution and bounded variance; and
generating a signal providing an indication of the predicted value associated with the data query.
